(19) United States
(12) Patent Application Publication
(10) Pub. No.: US 2016/0316338 A1
(43) Pub. Date: Oct. 27, 2016

(54) Device Control Method and Device

(71) Applicant: HUAWEI TECHNOLOGIES CO., LTD., Shenzhen, Guangdong (CN)

(72) Inventors: Zijun LI, Shenzhen (CN); Guoliang LI, Shenzhen (CN)

(73) Assignee: Huawei Technologies Co., Ltd.

(21) Appl. No.: 15/103,731

(22) PCT Filed: Dec. 10, 2013
(86) PCT No.: PCT/CN2013/088987

§ 371 Date: Jun. 10, 2016

(51) Int. Cl. H04W 4/02; H04W 36/08

(52) U.S. Cl. CPC H04W 4/027; H04W 36/08; H04W 84/12

(57) ABSTRACT

Embodiments of the present disclosure provide a device control method and a device. The method includes the following steps: receiving, by a terminal, a radio signal sent by a first access point device (S101), determining a corresponding first signal strength according to the radio signal sent by the first access point device (S102), acquiring a second signal strength, corresponding to the first access point device, of a first controlled device and a third signal strength, corresponding to the first access point device, of a second controlled device (S103), and when determining, according to the first signal strength, the second signal strength, and the third signal strength, that a distance between the first controlled device and the terminal is less than a distance between the second controlled device and the terminal, controlling the first controlled device and the second controlled device (S104).

### CROSS-REFERENCE TO RELATED APPLICATIONS

This application is a national stage application of international application number PCT/CN2013/088987 filed on Dec. 10, 2013, which is incorporated by reference.

### TECHNICAL FIELD

The present disclosure relates to the field of communications, and in particular, to a device control method and a device.

### BACKGROUND

With rapid development of technologies, an increasing number of controlled devices (such as, an intelligent television, an intelligent acoustic device, intelligent lighting, and the like) occur in people's daily life. In order to control these controlled devices, users need to use dedicated controllers, or install dedicated applications on mobile terminals, so as to control the controlled devices to start, stop, or execute specific functions.

In the prior art, users manually select required controlled devices to provide services. Specifically, the users may implement, by operating a mobile terminal, sharing of multi-media content (such as, images, audio, videos, and the like) between devices. For example, the users may transmit audio to an acoustic device by operating a music playback program on a mobile phone, and enable the acoustic device to play the audio.

However, when the controlled devices are distributed in multiple rooms, after a user moves to a new room, if the user wants to continue enjoying a service of a controlled device in the new room, the user needs to re-select, on the mobile terminal, a controlled device located in the new room to provide the service. For example, the user plays music by using an acoustic device in the living room, and when the user walks from the living room to another room, if the user wants to continue listening to music in this room, the user needs to select, by operating the mobile terminal, an acoustic device located in this room to play music. In this way, the user needs to re-select, by using the mobile terminal, a new acoustic device to play music, which increases complexity of operations of the user and decreases user experience.

### SUMMARY

Embodiments of the present disclosure provide a device control method and a device, so that a controlled device senses movement of a terminal, thereby improving user experience.

To achieve the foregoing objectives, the following technical solutions are used in the embodiments of the present disclosure.

According to a first aspect, a device control method is provided, including: receiving, by a terminal, a radio signal sent by a first access point device, where the first access point device includes at least one first access point device; determining a corresponding first signal strength according to the radio signal sent by the first access point device, where the first signal strength includes at least one first signal strength; acquiring a second signal strength, corresponding to the first access point device, of a first controlled device and a third signal strength, corresponding to the first access point device, of a second controlled device, where the second signal strength includes at least one second signal strength, and the third signal strength includes at least one third signal strength; and controlling the first controlled device and the second controlled device when determining, according to the first signal strength, the second signal strength, and the third signal strength, that a distance between the first controlled device and the terminal is less than a distance between the second controlled device and the terminal.

In a first possible implementation manner of the first aspect, the acquiring a second signal strength, corresponding to the first access point device, of a first controlled device and a third signal strength, corresponding to the first access point device, of a second controlled device includes: sending a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier; or, sending a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

With reference to the first possible implementation manner of the first aspect, in a second possible implementation manner of the first aspect, the first access point device includes at least three access point devices, the first signal strength corresponds to the at least three access point devices and includes at least three first signal strengths, the second signal strength corresponds to the at least three access point devices and includes at least three second signal strengths, and the third signal strength corresponds to the at least three access point devices and includes at least three third signal strengths; and the controlling the first controlled device and the second controlled device when determining, according to the first signal strength, the second signal strength, and the third signal strength, that a distance between the first controlled device and the terminal is less than a distance between the second controlled device and the terminal includes: determining a first difference value according to the first signal strength and the second signal strength, and determining a second difference value according to the first signal strength and the third signal strength, where the first difference value is a difference value between the first signal strength and the second signal strength that correspond to a second access point device, the second difference value is a difference value between the first signal strength and the third signal strength that correspond to the second access point device, and the first access point device includes the second access point device; and controlling the first controlled device and the second controlled device when determining, according to the first difference value and the second difference value, that the distance between the first controlled device and the terminal is less than the distance between the second controlled device and the terminal.

With reference to the second possible implementation manner of the first aspect, in a third possible implementation manner, the controlling the first controlled device and the second controlled device when determining, according to the first difference value and the second difference value, that the distance between the first controlled device and the terminal is less than the distance between the second controlled device and the terminal includes: when determining that the first difference value corresponding to the second access point device is less than the second difference value, determining that the distance between the first controlled device and the terminal is less than the distance between the second controlled device and the terminal; sending a first control instruction to the first controlled device, to instruct the first controlled device to provide a service for the terminal according to the first control instruction; and sending a second control instruction to the second controlled device, to instruct the second controlled device to stop providing a service for the terminal according to the second control instruction.

According to a second aspect, a device control method is provided, including: receiving, by a terminal, a first radio signal sent by a first controlled device, and determining a first signal strength according to the first radio signal; receiving a second radio signal sent by a second controlled device, and determining a second signal strength according to the second radio signal; and controlling the first controlled device and the second controlled device when determining, according to the first signal strength and the second signal strength, that a distance between the first controlled device and the terminal is less than a distance between the second controlled device and the terminal.

In a first possible implementation manner of the second aspect, the controlling the first controlled device and the second controlled device when determining, according to the first signal strength and the second signal strength, that a distance between the first controlled device and the terminal is less than a distance between the second controlled device and the terminal includes: when determining that the first signal strength is greater than the second signal strength, determining that the distance between the first controlled device and the terminal is less than the distance between the second controlled device and the terminal; sending a first control instruction to the first controlled device, to instruct the first controlled device to provide a service for the terminal according to the first control instruction; and sending a second control instruction to the second controlled device, to instruct the second controlled device to stop providing a service for the terminal according to the second control instruction.

According to a third aspect, a terminal is provided, including: an acquiring unit configured to receive a radio signal sent by a first access point device, where the first access point device includes at least one first access point device; and a processing unit configured to determine a corresponding first signal strength according to the radio signal sent by the first access point device and obtained by the acquiring unit, where the first signal strength includes at least one first signal strength, where the acquiring unit is further configured to acquire a second signal strength, corresponding to the first access point device, of a first controlled device and a third signal strength, corresponding to the first access point device, of a second controlled device, where the second signal strength includes at least one second signal strength, and the third signal strength includes at least one third signal strength; and the processing unit is further configured to: when it is determined, according to the first signal strength, the second signal strength, and the third signal strength, that a distance between the first controlled device and the terminal is less than a distance between the second controlled device and the terminal, control the first controlled device and the second controlled device.

In a first possible implementation manner of the third aspect, the terminal further includes: a sending unit configured to send a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier; or, send a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

With reference to the first possible implementation manner of the third aspect, in a second possible implementation manner of the third aspect, the first access point device includes at least three access point devices, the first signal strength corresponds to the at least three access point devices and includes at least three first signal strengths, the second signal strength corresponds to the at least three access point devices and includes at least three second signal strengths, and the third signal strength corresponds to the at least three access point devices and includes at least three third signal strengths; and the processing unit is specifically configured to: determine a first difference value according to the first signal strength and the second signal strength, and determine a second difference value according to the first signal strength and the third signal strength, where the first difference value is a difference value between the first signal strength and the second signal strength that correspond to a second access point device, the second difference value is a difference value between the first signal strength and the third signal strength that correspond to the second access point device, and the first access point device includes the second access point device; and when it is determined, according to the first difference value and the second difference value, that the distance between the first controlled device and the terminal is less than the distance between the second controlled device and the terminal, control the first controlled device and the second controlled device.

With reference to the second possible implementation manner of the third aspect, in a third possible implementation manner, the processing unit is specifically configured to: when it is determined that the first difference value corresponding to the second access point device is less than the second difference value, determine that the distance between the first controlled device and the terminal is less than the distance between the second controlled device and the terminal; and the sending unit is further configured to send: a first control instruction to the first controlled device to instruct the first controlled device to provide a service for the terminal according to the first control instruction, and send a second instruction to the second controlled device to instruct the second controlled device to stop providing a service for the terminal according to the second control instruction.

According to a fourth aspect, a terminal is provided, including: an acquiring unit configured to receive a first radio signal sent by a first controlled device, and receive a second radio signal sent by a second controlled device; and a processing unit configured to: determine a first signal strength according to the first radio signal obtained by the acquiring unit, determine a second signal strength according to the second radio signal obtained by the acquiring unit, and when it is determined, according to the first signal strength and the second signal strength, that a distance between the first controlled device and the terminal is less than a distance between the second controlled device and the terminal, control the first controlled device and the second controlled device.

In a first possible implementation manner of the fourth aspect, the processing unit is specifically configured to: when it is determined that the first signal strength is greater than the second signal strength, determine that the distance between the first controlled device and the terminal is less than the distance between the second controlled device and the terminal; and the terminal further includes: a sending unit configured to send: a first control instruction to the first controlled device to instruct the first controlled device to provide a service for the terminal according to the first control instruction, and send a second instruction to the second controlled device to instruct the second controlled device to stop providing a service for the terminal according to the second control instruction.

According to a fifth aspect, a device control system is provided, including a first access point device, a terminal, a first controlled device, and a second controlled device, where the first access point device includes at least three access point devices, where the first access point device is configured to send a radio signal to the terminal, the first controlled device, and the second controlled device; the terminal is configured to: receive the radio signal sent by the first access point device, determine a corresponding first signal strength according to the radio signal sent by the first access point device, acquire a second signal strength, corresponding to the first access point device, of the first controlled device and a third signal strength, corresponding to the first access point device, of the second controlled device, and when determining, according to the first signal strength, the second signal strength, and the third signal strength, that a distance between the first controlled device and the terminal is less than a distance between the second controlled device and the terminal, control the first controlled device and the second controlled device, where the first signal strength includes at least one first signal strength, the second signal strength includes at least one second signal strength, and the third signal strength includes at least one third signal strength; the first controlled device is configured to: receive the radio signal sent by the first access point device, determine a corresponding second signal strength according to the radio signal sent by the first access point device, and send the second signal strength to the terminal; and the second controlled device is configured to: receive the radio signal sent by the first access point device, determine a corresponding third signal strength according to the radio signal sent by the first access point device, and send the third signal strength to the terminal.

According to a sixth aspect, a device control system is provided, including a first controlled device, a second controlled device, and a terminal, where the first controlled device is configured to send a first radio signal to the terminal; the second controlled device is configured to send a second radio signal to the terminal; and the terminal is configured to: determine a first signal strength according to the first radio signal, determine a second signal strength according to the second radio signal, and when determining, according to the first signal strength and the second signal strength, that a distance between the first controlled device and the terminal is less than a distance between the second controlled device and the terminal, control the first controlled device and the second controlled device.

According to a seventh aspect, a terminal is provided, including a processor and a memory, where the memory stores a computer executable instruction, and the processor is connected to the memory by using a communications bus; and when the terminal runs, the processor executes the computer executable instruction stored in the memory, so that the terminal executes the method according to the first aspect.

According to an eighth aspect, a terminal is provided, including a processor and a memory, where the memory stores a computer executable instruction, and the processor is connected to the memory by using a communications bus; and when the terminal runs, the processor executes the computer executable instruction stored in the memory, so that the controlled device executes the method according to the second aspect.

By using the foregoing solutions, a terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic flowchart of a device control method according to an embodiment of the present disclosure;

FIG. 2 is a schematic flowchart of another device control method according to an embodiment of the present disclosure;

FIG. 3 is a flowchart of a device control method according to an embodiment of the present disclosure;

FIG. 4 is a flowchart of another device control method according to an embodiment of the present disclosure;

FIG. 5 is a schematic structural diagram of a terminal according to an embodiment of the present disclosure;

FIG. 6 is a schematic structural diagram of another terminal according to an embodiment of the present disclosure;

FIG. 7 is a connection diagram of a device control system according to an embodiment of the present disclosure;

FIG. 8 is a connection diagram of another device control system according to an embodiment of the present disclosure;

FIG. 9 is a schematic structural diagram of another terminal according to an embodiment of the present disclosure; and

FIG. 10 is a schematic structural diagram of still another terminal according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

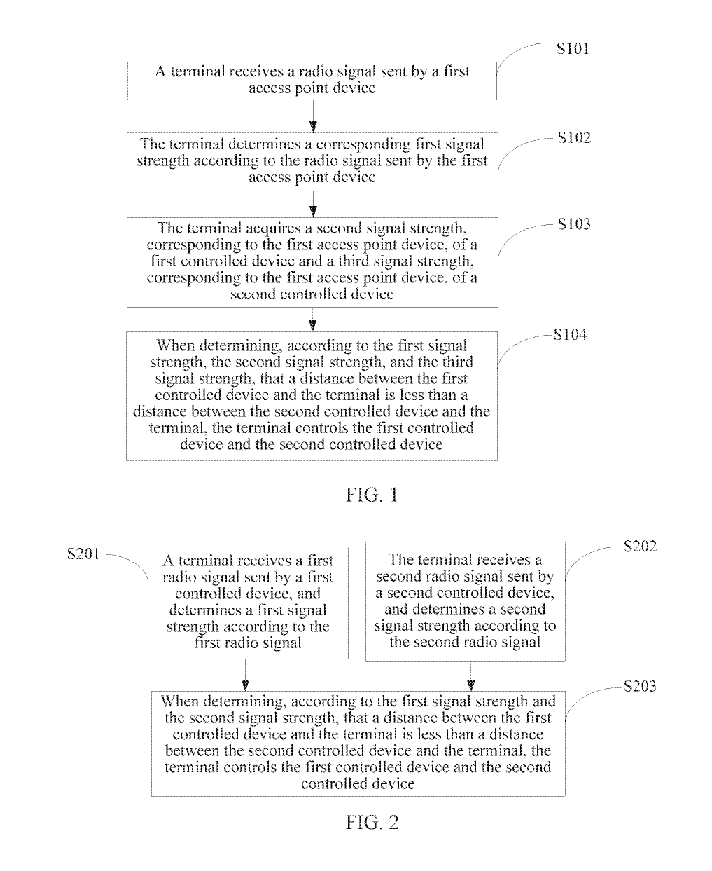

An embodiment of the present disclosure provides a device control method. As shown in FIG. 1, the method is executed by a terminal, and the method includes:

S101: A terminal receives a radio signal sent by a first access point device.

The first access point device includes at least one first access point device.

Specifically, the terminal and a controlled device are connected by using an access point device, where the access point device includes a working access point device used for implementing network communication between the terminal and the controlled device and at least two auxiliary access point devices used for providing a radio signal to determine a distance between the terminal and the controlled device. The working access point device may also be used as an auxiliary access point device, and when determining a signal strength, the working access point device is used as an auxiliary access point device. This embodiment of the present disclosure is described by collectively referring to the working access point device and the auxiliary access point device as access point devices.

S102: The terminal determines a corresponding first signal strength according to the radio signal sent by the first access point device.

The first signal strength includes at least one first signal strength.

Specifically, the first access point device includes at least three access point devices, and the terminal receives at least three radio signals sent by the at least three access point devices, and obtains at least three first signal strengths according to the at least three radio signals.

Exemplarily, the terminal determines a signal strength A1 according to a received radio signal sent by an access point device 1, determines a signal strength A2 according to a received radio signal sent by an access point device 2, and determines a signal strength A3 according to a radio signal sent by an access point device 3.

S103: The terminal acquires a second signal strength, corresponding to the first access point device, of a first controlled device and a third signal strength, corresponding to the first access point device, of a second controlled device.

The second signal strength includes at least one second signal strength, and the third signal strength includes at least one third signal strength.

Specifically, the terminal sends a signal strength request instruction to the first controlled device and the second controlled device, to instruct the first controlled device and the second controlled device to respectively send the second signal strength and the third signal strength to the terminal according to the signal strength request instruction.

The second signal strength includes at least three signal strengths obtained when the first controlled device receives the radio signals of the at least three first access point devices, and the third signal strength includes at least three signal strengths obtained when the second controlled device receives the radio signals of the at least three first access point devices.

Specifically, the terminal may send the signal strength request instruction in a broadcast manner; after receiving the signal strength request instruction, the first controlled device sends at least three second signal strengths corresponding to the at least three first access point devices and identifier information of the first controlled device to the terminal; and after receiving the signal strength request instruction, the second controlled device sends at least three third signal strengths corresponding to the at least three first access point devices and identifier information of the second controlled device to the terminal. In this way, the terminal can determine, according to the identifier information, a sending party corresponding to the received signal strength. Certainly, the terminal may also directly send the signal strength request instruction to the first controlled device and the second controlled device; after receiving the signal strength request instruction, the first controlled device sends at least three second signal strengths corresponding to the at least three first access point devices to the terminal; and after receiving the signal strength request instruction, the second controlled device sends at least three third signal strengths corresponding to the at least three first access point devices to the terminal, which is not limited in the present disclosure.

It should be noted that, because the first controlled device and the second controlled device send signal strengths corresponding to multiple access point devices to the terminal, when sending the signal strengths to the terminal, the first controlled device and the second controlled device also need to send an identifier of an access point device corresponding to each signal strength to the terminal, so as to notify the terminal of an access point device corresponding to the received signal strength.

Optionally, the terminal sends the signal strength request instruction to the first controlled device and the second controlled device, and acquires the second signal strength, corresponding to the first access point device, of the first controlled device and the third signal strength, corresponding to the first access point device, of the second controlled device in the following two manners:

Manner 1: the terminal sends a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier.

Specifically, the access point device may be a wireless fidelity (Wi-Fi) access point (AP), and an identifier of the access point device may be a service set identifier (SSID) of the Wi-Fi access point. The terminal may send a signal strength request instruction including the service set identifier to the first controlled device and the second controlled device, to instruct the first controlled device and the second controlled device to determine to send to the terminal the signal strength that is determined according to a radio signal sent by a Wi-Fi access point corresponding to the service set identifier. In this way, the terminal can send a signal request instruction including the service set identifier of a Wi-Fi access point required by the terminal to the first controlled device and the second controlled device, to instruct the first controlled device and the second controlled device to send to the terminal the first signal strength and the second signal strength that correspond to a Wi-Fi access point determined according to the service set identifier.

Exemplarily, the signal strength request instruction sent by the terminal to the first controlled device and the second controlled device includes an identifier of an access point device 1, an identifier of an access point device 2, and an identifier of an access point device 3, and then, after receiving the signal strength request instruction, the first controlled device sends a signal strength B1 corresponding to the access point device 1, a signal strength B2 corresponding to the access point device 2, and a signal strength B3 corresponding to the access point device 3; similarly, after receiving the signal strength request instruction, the second controlled device sends a signal strength C1 corresponding to the access point device 1, a signal strength C2 corresponding to the access point device 2, and a signal strength C3 corresponding to the access point device 3 to the terminal.

Manner 2: the terminal sends a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

It should be noted that, different from Manner 1, in this manner, the signal strength request instruction sent by the terminal does not include an identifier of an access point device.

In addition, the second signal strength and the third signal strength include signal strengths that are obtained by the first controlled device and the second controlled device according to radio signals sent by at least three identical access point devices.

Exemplarily, in a scenario of Manner 2, there are five access point devices, namely, access point devices 1 to 5. The first controlled device detects the access point devices 1 to 4, marks a signal strength corresponding to a radio signal sent by the access point device 1 and acquired by the first controlled device as B1, marks a signal strength corresponding to a radio signal sent by the access point device 2 and acquired by the first controlled device as B2, and so on; then, the signal strengths, acquired by the first controlled device, of the access point devices 1 to 4 are B1, B2, B3, and B4 respectively. After receiving the signal strength request instruction sent by the terminal, the first controlled device sends the four second signal strengths B1, B2, B3, and B4 to the terminal. Similarly, the second controlled device detects the access point devices 2 to 5, marks a signal strength corresponding to a radio signal sent by the access point device 2 and acquired by the second controlled device as C2, marks a signal strength corresponding to a radio signal sent by the access point device 3 and acquired by the second controlled device as C3, and so on; then, the signal strengths, acquired by the second controlled device, corresponding to the access point devices 2 to 5 are C2, C3, C4, and C5 respectively. After receiving the signal strength request instruction sent by the terminal, the second controlled device sends the four third signal strengths C2, C3, C4, and C5 to the terminal. The second signal strength and the third signal strength both include the signal strengths obtained according to the radio signals sent by the access point devices 2 to 4. It is only exemplary description herein, and no limitation is imposed thereto.

S104: When determining, according to the first signal strength, the second signal strength, and the third signal strength, that a distance between the first controlled device and the terminal is less than a distance between the second controlled device and the terminal, the terminal controls the first controlled device and the second controlled device.

The first access point device includes at least three access point devices, the first signal strength corresponds to the at least three access point devices and includes at least three first signal strengths, the second signal strength corresponds to the at least three access point devices and includes at least three second signal strengths, and the third signal strength corresponds to the at least three access point devices and includes at least three third signal strengths.

Specifically, the terminal determines a first difference value according to the first signal strength and the second signal strength, and determines a second difference value according to the first signal strength and the third signal strength, where the first difference value is a difference value between the first signal strength and the second signal strength that correspond to a second access point device, and the second difference value is a difference value between the first signal strength and the third signal strength that correspond to the second access point device, where the first access point device includes the second access point device; and when determining, according to the first difference value and the second difference value, that the distance between the first controlled device and the terminal is less than the distance between the second controlled device and the terminal, controls the first controlled device and the second controlled device.

It should be noted that, the terminal determines the first difference value according to the first signal strength and the second signal strength that correspond to a same access point device; therefore, the first controlled device and the second controlled device are required to send second signal strengths and third signal strengths that correspond to at least three identical access point devices to the terminal.

Further, when determining that the first difference value corresponding to the second access point device is less than the second difference value, the terminal determines that the distance between the first controlled device and the terminal is less than the distance between the second controlled device and the terminal.

It should be noted that, the terminal determines the first difference value and the second difference value according to signal strengths determined according to radio signals sent by the same access point device, in this way, the first difference value can be compared with the second difference value.

Specifically, when determining that at least three first difference values are respectively less than second difference values corresponding to corresponding access point devices, the terminal determines that the distance between the first controlled device and the terminal is less than the distance between the second controlled device and the terminal.

Exemplarily, in an application scenario of this embodiment of the present disclosure, there are five access point devices, namely, access point devices 1 to 5. The terminal obtains a signal strength A1 according to a radio signal sent by the access point device 1, the first controlled device obtains a signal strength B1 according to the radio signal sent by the access point device 1, and the second controlled device obtains a signal strength C1 according to the radio signal sent by the access point device 1. The terminal obtains a signal strength A2 according to a radio signal sent by the access point device 2, the first controlled device obtains a signal strength B2 according to the radio signal sent by the access point device 2, and the second controlled device obtains a signal strength C2 according to the radio signal sent by the access point device 2. The terminal obtains a signal strength A3 according to a radio signal sent by the access point device 3, the first controlled device obtains a signal strength B3 according to the radio signal sent by the access point device 3, and the second controlled device obtains a signal strength C3 according to the radio signal sent by the access point device 3. If it is determined that a difference value between A1 and B1 is less than a difference value between A1 and C1, a difference value between A2 and B2 is less than a difference value between A2 and C2, and a difference value between A3 and B3 is less than a difference value between A3 and C3, it is determined that the first controlled device is closer to the terminal than the second controlled device is. In addition, judgment may also be performed according to a preset threshold. If it is determined that the difference value between A1 and B1, the difference value between A2 and B2, and the difference value between A3 and B3 are all less than the preset threshold, and any one of the difference value between A1 and C1, the difference value between A2 and C2, and the difference value between A3 and C3 is greater than the preset threshold, it is determined that the first controlled device is closer to the terminal than the second controlled device is. It is only exemplary description herein, and no limitation is imposed thereto.

Further, when determining that the distance between the first controlled device and the terminal is less than the distance between the second controlled device and the terminal, the terminal sends a first control instruction to the first controlled device, to instruct the first controlled device to provide a service for the terminal according to the first control instruction, and sends a second control instruction to the second controlled device, to instruct the second controlled device to stop providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

It should be noted that, this embodiment of the present disclosure does not limit that step S101 to step S104 are executed in a scenario in which the terminal moves. In a scenario in which the terminal is powered up and sends a playback instruction to the first controlled device and the second controlled device, a controlled device approaching the terminal may also be determined with reference to this embodiment of the present disclosure, and the controlled device provides a service.

By using the foregoing method executed by a terminal, the terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

An embodiment of the present disclosure provides a device control method. As shown in FIG. 2, the method includes:

S201: A terminal receives a first radio signal sent by a first controlled device, and determines a first signal strength according to the first radio signal.

S202: The terminal receives a second radio signal sent by a second controlled device, and determines a second signal strength according to the second radio signal.

Specifically, the terminal and the controlled device may be connected in a point-to-point connection manner, for example, the Bluetooth or the point-to-point wireless fidelity protocol (Wi-Fi Direct). The terminal establishes connections to the first controlled device and the second controlled device. After the connection is established, the terminal acquires the first radio signal sent by the first controlled device, and obtains the first signal strength according to the first radio signal; acquires the second radio signal sent by the second controlled device, and obtains the second signal strength according to the second radio signal.

S203: When determining, according to the first signal strength and the second signal strength, that a distance between the first controlled device and the terminal is less than a distance between the second controlled device and the terminal, the terminal controls the first controlled device and the second controlled device.

Further, when determining that the first signal strength is greater than the second signal strength, the terminal determines that the first controlled device is closer to the terminal than the second controlled device is.

Specifically, in this manner, the terminal directly establishes connections to the first controlled device and the second controlled device. After receiving the first signal strength and the second signal strength, because a shorter distance to the terminal indicates that a signal strength of the radio signal received by the terminal is larger, when determining that the first signal strength is greater than the second signal strength, the terminal determines that the first controlled device is closer to the terminal than the second controlled device is.

Further, when it is determined that the first controlled device is closer to the terminal than the second controlled device is, a first control instruction is sent to the first controlled device, to instruct the first controlled device to execute the first control instruction, so that the first controlled device provides a service for the terminal according to the first control instruction; a second control instruction is sent to the second controlled device, to instruct the second controlled device to execute the second control instruction, so that the second controlled device stops providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal. The first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

It should be noted that, this embodiment of the present disclosure does not limit that step S201 to step S203 are executed in a scenario in which the terminal moves. In a scenario in which the terminal is powered up and sends a playback instruction to the first controlled device and the second controlled device, a controlled device approaching the terminal may also be determined with reference to this embodiment of the present disclosure, and the controlled device provides a service.

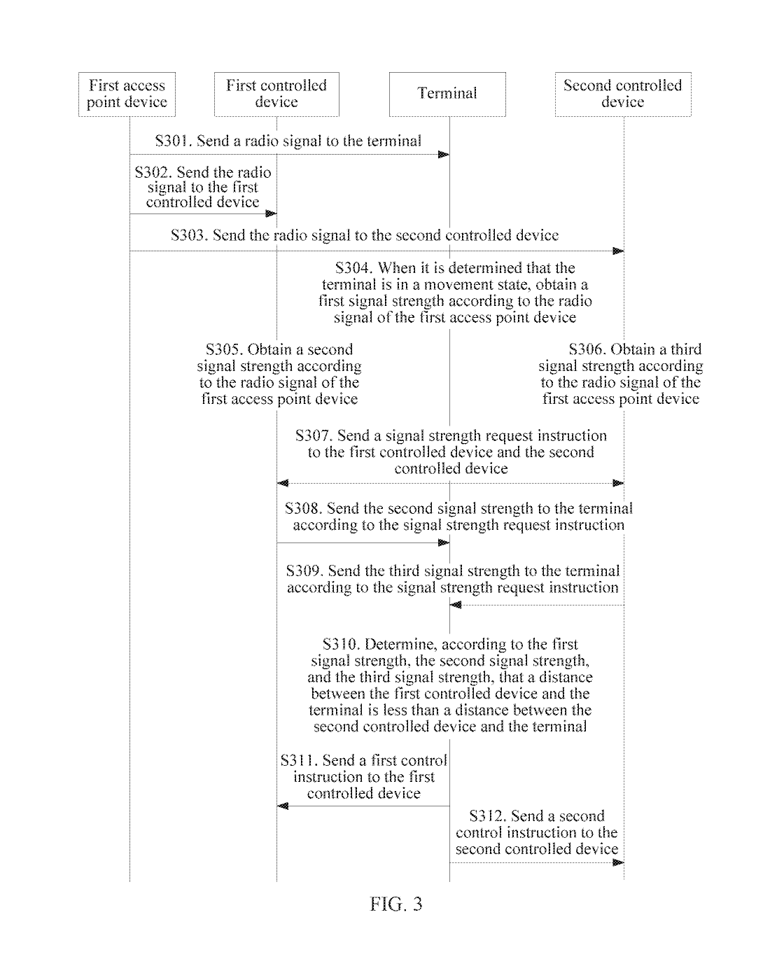

An embodiment of the present disclosure provides a terminal. As shown in FIG. 3, the method embodiment is described in a scenario in which a terminal is connected to a controlled device by using an access point device, and the method includes:

S301: A first access point device sends a radio signal to a terminal.

S302: The first access point device sends the radio signal to a first controlled device.

S303: The first access point device sends the radio signal to a second controlled device.

Specifically, the first access point device includes a working access point device used for implementing network communication between the terminal and the controlled device and at least two auxiliary access point devices used for providing a radio signal to determine a distance between the terminal and the controlled device. The working access point device may also be used as an auxiliary access point device, and when determining a signal strength, the working access point device is used as an auxiliary access point device. This embodiment of the present disclosure is described by collectively referring to the working access point device and the auxiliary access point device as access point devices.

S304: When determining that terminal is in a movement state, the terminal obtains a first signal strength according to the radio signal of the first access point device.

Specifically, the terminal determines by using a sensor (for example, a gravity sensor, a gyroscope, or an acceleration sensor) that the terminal is in a movement state.

S305: The first controlled device obtains a second signal strength according to the radio signal of the first access point device.

S306: The second controlled device obtains a third signal strength according to the radio signal of the first access point device.

Specifically, the first access point device includes at least three access point devices, and the terminal receives at least three radio signals sent by the at least three access point devices, and obtains at least three first signal strengths according to the at least three radio signals. Similarly, the first controlled device receives at least three radio signals sent by the at least three access point devices, and obtains at least three second signal strengths according to the at least three radio signals. Similarly, the second controlled device receives the at least three radio signals sent by the at least three access point devices, and obtains at least three third signal strengths according to the at least three radio signals.

S307: The terminal sends a signal strength request instruction to the first controlled device and the second controlled device.

Specifically, the terminal sends a signal strength request instruction to the first controlled device and the second controlled device, to instruct the first controlled device and the second controlled device to respectively send the first signal strength and the second signal strength to the terminal according to the signal strength request instruction.

The second signal strength includes at least three signal strengths obtained when the first controlled device receives the radio signals of the at least three first access point devices, and the third signal strength includes at least three signal strengths obtained when the second controlled device receives the radio signals of the at least three first access point devices.

S308: The first controlled device sends the second signal strength to the terminal according to the signal strength request instruction.

S309: The second controlled device sends the third signal strength to the terminal according to the signal strength request instruction.

Specifically, the terminal may send the signal strength request instruction in a broadcast manner; after receiving the signal strength request instruction, the first controlled device sends at least three second signal strengths corresponding to the at least three first access point devices and identifier information of the first controlled device to the terminal; and after receiving the signal strength request instruction, the second controlled device sends at least three third signal strengths corresponding to the at least three first access point devices and identifier information of the second controlled device to the terminal. In this way, the terminal can determine, according to the identifier information, a sending party corresponding to the received signal strength. Certainly, the terminal may also directly send the signal strength request instruction to the first controlled device and the second controlled device; after receiving the signal strength request instruction, the first controlled device sends at least three second signal strengths corresponding to the at least three first access point devices to the terminal; and after receiving the signal strength request instruction, the second controlled device sends at least three third signal strengths corresponding to the at least three first access point devices to the terminal, which is not limited in the present disclosure.

It should be noted that, because the first controlled device and the second controlled device send signal strengths corresponding to multiple access point devices to the terminal, when sending the signal strengths to the terminal, the first controlled device and the second controlled device also need to send an identifier of an access point device corresponding to each signal strength to the terminal, so as to notify the terminal of an access point device corresponding to the received signal strength.

Optionally, the terminal sends the signal strength request instruction to the first controlled device and the second controlled device, and acquires the second signal strength, corresponding to the first access point device, of the first controlled device and the third signal strength, corresponding to the first access point device, of the second controlled device in the following two manners:

Manner 1: the terminal sends a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier.

Specifically, the access point device may be a Wi-Fi AP, and an identifier of the access point device may be an SSID of the Wi-Fi access point. The terminal may send a signal strength request instruction including the service set identifier to the first controlled device and the second controlled device, to instruct the first controlled device and the second controlled device to determine to send to the terminal the signal strength that is determined according to a radio signal sent by a Wi-Fi access point corresponding to the service set identifier. In this way, the terminal can send a signal request instruction including the service set identifier of a Wi-Fi access point required by the terminal to the first controlled device and the second controlled device, to instruct the first controlled device and the second controlled device to send to the terminal the first signal strength and the second signal strength that correspond to a Wi-Fi access point determined according to the service set identifier.

Exemplarily, the signal strength request instruction sent by the terminal to the first controlled device and the second controlled device includes an identifier of an access point device 1, an identifier of an access point device 2, and an identifier of an access point device 3, and then, after receiving the signal strength request instruction, the first controlled device sends a signal strength B1 corresponding to the access point device 1, a signal strength B2 corresponding to the access point device 2, and a signal strength B3 corresponding to the access point device 3; similarly, after receiving the signal strength request instruction, the second controlled device sends a signal strength C1 corresponding to the access point device 1, a signal strength C2 corresponding to the access point device 2, and a signal strength C3 corresponding to the access point device 3 to the terminal.

Manner 2: the terminal sends a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

It should be noted that, different from Manner 1, in this manner, the signal strength request instruction sent by the terminal does not include an identifier of an access point device.

In addition, the second signal strength and the third signal strength include signal strengths that are obtained by the first controlled device and the second controlled device according to radio signals sent by at least three identical access point devices.

Exemplarily, in a scenario of Manner 2, there are five access point devices, namely, access point devices 1 to 5. The first controlled device detects the access point devices 1 to 4, marks a signal strength corresponding to a radio signal sent by the access point device 1 and acquired by the first controlled device as B1, marks a signal strength corresponding to a radio signal sent by the access point device 2 and acquired by the first controlled device as B2, and so on; then, the signal strengths, acquired by the first controlled device, of the access point devices 1 to 4 are B1, B2, B3, and B4 respectively. After receiving the signal strength request instruction sent by the terminal, the first controlled device sends the four second signal strengths B1, B2, B3, and B4 to the terminal. Similarly, the second controlled device detects the access point devices 2 to 5, marks a signal strength corresponding to a radio signal sent by the access point device 2 and acquired by the second controlled device as C2, marks a signal strength corresponding to a radio signal sent by the access point device 3 and acquired by the second controlled device as C3, and so on; then, the signal strengths, acquired by the second controlled device, corresponding to the access point devices 2 to 5 are C2, C3, C4, and C5 respectively. After receiving the signal strength request instruction sent by the terminal, the second controlled device sends the four third signal strengths C2, C3, C4, and C5 to the terminal. The second signal strength and the third signal strength both include the signal strengths obtained according to the radio signals sent by the access point devices 2 to 4. It is only exemplary description herein, and no limitation is imposed thereto.

S310: The terminal determines, according to the first signal strength, the second signal strength, and the third signal strength, that a distance between the first controlled device and the terminal is less than a distance between the second controlled device and the terminal.

The first access point device includes at least three access point devices, the first signal strength corresponds to the at least three access point devices and includes at least three first signal strengths, the second signal strength corresponds to the at least three access point devices and includes at least three second signal strengths, and the third signal strength corresponds to the at least three access point devices and includes at least three third signal strengths.

Specifically, the terminal determines a first difference value according to the first signal strength and the second signal strength, and determines a second difference value according to the first signal strength and the third signal strength, where the first difference value is a difference value between the first signal strength and the second signal strength that correspond to a second access point device, and the second difference value is a difference value between the first signal strength and the third signal strength that correspond to the second access point device, where the first access point device includes the second access point device; and determines, according to the first difference value and the second difference value, that a distance between the first controlled device and the terminal is less than a distance between the second controlled device and the terminal.

It should be noted that, the terminal determines the first difference value according to the first signal strength and the second signal strength that correspond to a same access point device; therefore, the first controlled device and the second controlled device are required to send second signal strengths and third signal strengths that correspond to at least three identical access point devices to the terminal.

Further, when determining that the first difference value corresponding to the second access point device is less than the second difference value, the terminal determines that the distance between the first controlled device and the terminal is less than the distance between the second controlled device and the terminal.

It should be noted that, the terminal determines the first difference value and the second difference value according to signal strengths determined according to radio signals sent by the same access point device, in this way, the first difference value can be compared with the second difference value.

Specifically, when determining that at least three first difference values are respectively less than second difference values corresponding to corresponding access point devices, the terminal determines that the distance between the first controlled device and the terminal is less than the distance between the second controlled device and the terminal.

Exemplarily, in an application scenario of this embodiment of the present disclosure, there are five access point devices, namely, access point devices 1 to 5. The terminal obtains a signal strength A1 according to a radio signal sent by the access point device 1, the first controlled device obtains a signal strength B1 according to the radio signal sent by the access point device 1, and the second controlled device obtains a signal strength C1 according to the radio signal sent by the access point device 1. The terminal obtains a signal strength A2 according to a radio signal sent by the access point device 2, the first controlled device obtains a signal strength B2 according to the radio signal sent by the access point device 2, and the second controlled device obtains a signal strength C2 according to the radio signal sent by the access point device 2. The terminal obtains a signal strength A3 according to a radio signal sent by the access point device 3, the first controlled device obtains a signal strength B3 according to the radio signal sent by the access point device 3, and the second controlled device obtains a signal strength C3 according to the radio signal sent by the access point device 3. If it is determined that a difference value between A1 and B1 is less than a difference value between A1 and C1, a difference value between A2 and B2 is less than a difference value between A2 and C2, and a difference value between A3 and B3 is less than a difference value between A3 and C3, it is determined that the first controlled device is closer to the terminal than the second controlled device is. In addition, judgment may also be performed according to a preset threshold. If it is determined that the difference value between A1 and B1, the difference value between A2 and B2, and the difference value between A3 and B3 are all less than the preset threshold, and any one of the difference value between A1 and C1, the difference value between A2 and C2, and the difference value between A3 and C3 is greater than the preset threshold, it is determined that the first controlled device is closer to the terminal than the second controlled device is. It is only exemplary description herein, and no limitation is imposed thereto.

S311: The terminal sends a first control instruction to the first controlled device.

The first control instruction is used to instruct the first controlled device to provide a service for the terminal.

S312: The terminal sends a second control instruction to the second controlled device.

The second control instruction is used to instruct the second controlled device to stop providing a service for the terminal.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

By using the foregoing solution, a terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

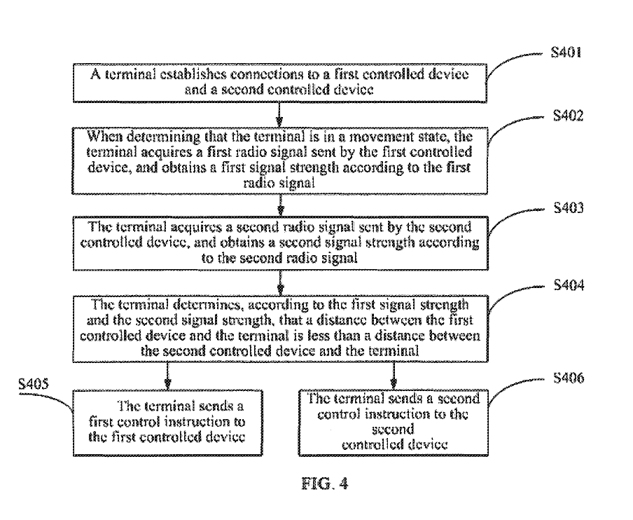

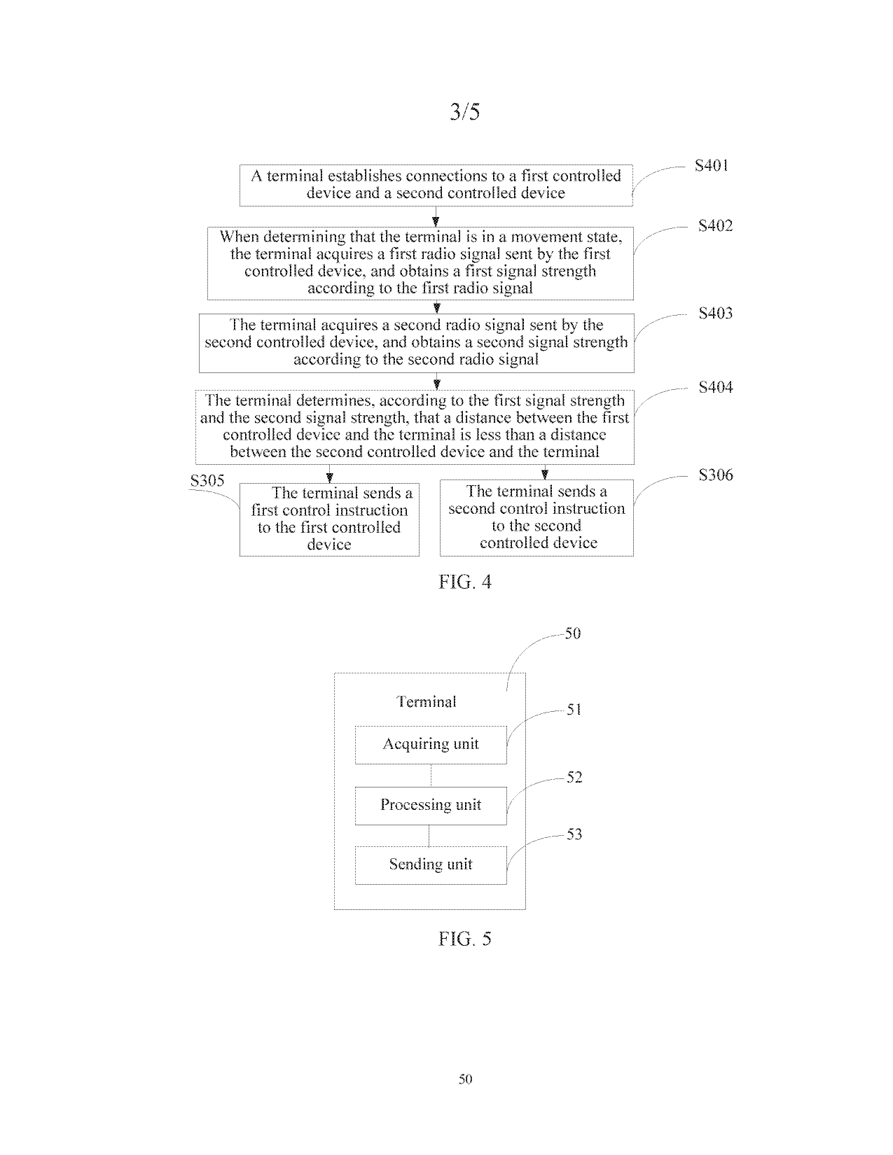

An embodiment of the present disclosure provides a device control method. As shown in FIG. 4, the method embodiment is described by using an example in which the terminal is connected to a controlled device in a point-to-point connection manner (for example, the Bluetooth or the point-to-point wireless fidelity protocol). The method includes:

S401: A terminal establishes connections to a first controlled device and a second controlled device.

S402: When determining that the terminal is in a movement state, the terminal acquires a first radio signal sent by the first controlled device, and obtains a first signal strength according to the first radio signal.

Specifically, the terminal determines by using a sensor (for example, a gravity sensor, a gyroscope, or an acceleration sensor) that the terminal is in a movement state.

S403: The terminal acquires a second radio signal sent by the second controlled device, and obtains a second signal strength according to the second radio signal.

S404: The terminal determines, according to the first signal strength and the second signal strength, that a distance between the first controlled device and the terminal is less than a distance between the second controlled device and the terminal.

Specifically, when determining that the first signal strength is greater than the second signal strength, the terminal determines that the distance between the first controlled device and the terminal is less than the distance between the second controlled device and the terminal.

It should be noted that, in this embodiment of the present disclosure, the terminal directly establishes connections to the first controlled device and the second controlled device. After receiving the first signal strength and the second signal strength, because a shorter distance to the terminal indicates that a signal strength of the radio signal received by the terminal is larger, when determining that the first signal strength is greater than the second signal strength, the terminal determines that the distance between the first controlled device and the terminal is less than the distance between the second controlled device and the terminal.

S405: The terminal sends a first control instruction to the first controlled device.

The first control instruction is used to instruct the first controlled device to provide a service according to the first control instruction.

S406: The terminal sends a second control instruction to the second controlled device.

The second control instruction is used to instruct the second controlled device to stop providing a service according to the second control instruction.

Specifically, when it is determined that the first controlled device is closer to the terminal than the second controlled device is, a first control instruction is sent to the first controlled device, to instruct the first controlled device to execute the first control instruction, so that the first controlled device provides a service for the terminal according to the first control instruction; a second control instruction is sent to the second controlled device, to instruct the second controlled device to execute the second control instruction, so that the second controlled device stops providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal. The first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

It should be noted that, this embodiment of the present disclosure does not limit that step S401 to step S406 are executed in a scenario in which the terminal moves. In a scenario in which the terminal is powered up and sends a playback instruction to the first controlled device and the second controlled device, a controlled device approaching the terminal may also be determined with reference to this embodiment of the present disclosure, and the controlled device provides a service.

In this way, when a terminal is connected to a controlled device in a point-to-point connection manner, the terminal senses a relationship between distances between the controlled device and the terminal, so as to execute a corresponding operation according to the relationship between distances, thereby improving user experience.

An embodiment of the present disclosure provides a terminal 50. As shown in FIG. 5, the terminal 50 includes: an acquiring unit 51 configured to receive a radio signal sent by a first access point device, where the first access point device includes at least one first access point device; and a processing unit 52 configured to determine a corresponding first signal strength according to the radio signal sent by the first access point device and obtained by the acquiring unit, where the first signal strength includes at least one first signal strength, where the acquiring unit 51 is further configured to acquire a second signal strength, corresponding to the first access point device, of a first controlled device and a third signal strength, corresponding to the first access point device, of a second controlled device, where the second signal strength includes at least one second signal strength, and the third signal strength includes at least one third signal strength; and the processing unit 52 is further configured to: when it is determined, according to the first signal strength, the second signal strength, and the third signal strength, that a distance between the first controlled device and the terminal is less than a distance between the second controlled device and the terminal, control the first controlled device and the second controlled device.

The first access point device includes a working access point device used for implementing network communication between the terminal and the controlled device and at least two auxiliary access point devices used for providing a radio signal to determine a distance between the terminal and the controlled device. The working access point device may also be used as an auxiliary access point device, and when determining a signal strength, the working access point device is used as an auxiliary access point device. This embodiment of the present disclosure is described by collectively referring to the working access point device and the auxiliary access point device as access point devices.

Further, the terminal sends a signal strength request instruction to the first controlled device and the second controlled device, to instruct the first controlled device and the second controlled device to respectively send the first signal strength and the second signal strength to the terminal according to the signal strength request instruction.

Specifically, the terminal may send the signal strength request instruction in a broadcast manner; after receiving the signal strength request instruction, the first controlled device sends at least three second signal strengths corresponding to at least three first access point devices and identifier information of the first controlled device to the terminal; and after receiving the signal strength request instruction, the second controlled device sends at least three third signal strengths corresponding to the at least three first access point devices and identifier information of the second controlled device to the terminal. In this way, the terminal can determine, according to the identifier information, a sending party corresponding to the received signal strength. Certainly, the terminal may also directly send the signal strength request instruction to the first controlled device and the second controlled device; after receiving the signal strength request instruction, the first controlled device sends at least three second signal strengths corresponding to the at least three first access point devices to the terminal; and after receiving the signal strength request instruction, the second controlled device sends at least three third signal strengths corresponding to the at least three first access point devices to the terminal, which is not limited in the present disclosure.

It should be noted that, because the first controlled device and the second controlled device send signal strengths corresponding to multiple access point devices to the terminal, when sending the signal strengths to the terminal, the first controlled device and the second controlled device also need to send an identifier of an access point device corresponding to each signal strength to the terminal, so as to notify the terminal of an access point device corresponding to the received signal strength.

Optionally, the terminal further includes a sending unit 53 configured to send a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier.

Specifically, the access point device may be a Wi-Fi AP, and an identifier of the access point device may be an SSID of the Wi-Fi access point. The terminal may send a signal strength request instruction including the service set identifier to the first controlled device and the second controlled device, to instruct the first controlled device and the second controlled device to determine to send to the terminal the signal strength that is determined according to a radio signal sent by a Wi-Fi access point corresponding to the service set identifier. In this way, the terminal can send a signal request instruction including the service set identifier of a Wi-Fi access point required by the terminal to the first controlled device and the second controlled device, to instruct the first controlled device and the second controlled device to send to the terminal the first signal strength and the second signal strength that correspond to a Wi-Fi access point determined according to the service set identifier.

Exemplarily, the signal strength request instruction sent by the terminal to the first controlled device and the second controlled device includes an identifier of an access point device 1, an identifier of an access point device 2, and an identifier of an access point device 3, and then, after receiving the signal strength request instruction, the first controlled device sends a signal strength B1 corresponding to the access point device 1, a signal strength B2 corresponding to the access point device 2, and a signal strength B3 corresponding to the access point device 3; similarly, after receiving the signal strength request instruction, the second controlled device sends a signal strength C1 corresponding to the access point device 1, a signal strength C2 corresponding to the access point device 2, and a signal strength C3 corresponding to the access point device 3 to the terminal.

Optionally, the sending unit 53 is further configured to send a signal strength request instruction to the first controlled device and the second controlled device, to instruct the first controlled device and the second controlled device to respectively send detected second signal strengths and third signal strengths that correspond to all access point devices to the terminal.

The all access point devices include the first access point device.

It should be noted that, different from Manner 1, in this manner, the signal strength request instruction sent by the terminal does not include an identifier of an access point device.

In addition, the second signal strength and the third signal strength include signal strengths that are obtained by the first controlled device and the second controlled device according to radio signals sent by at least three identical access point devices.

Exemplarily, in a scenario of Manner 2, there are five access point devices, namely, access point devices 1 to 5. The first controlled device detects the access point devices 1 to 4, marks a signal strength corresponding to a radio signal sent by the access point device 1 and acquired by the first controlled device as B1, marks a signal strength corresponding to a radio signal sent by the access point device 2 and acquired by the first controlled device as B2, and so on; then, the signal strengths, acquired by the first controlled device, of the access point devices 1 to 4 are B1, B2, B3, and B4 respectively. After receiving the signal strength request instruction sent by the terminal, the first controlled device sends the four second signal strengths B1, B2, B3, and B4 to the terminal. Similarly, the second controlled device detects the access point devices 2 to 5, marks a signal strength corresponding to a radio signal sent by the access point device 2 and acquired by the second controlled device as C2, marks a signal strength corresponding to a radio signal sent by the access point device 3 and acquired by the second controlled device as C3, and so on; then, the signal strengths, acquired by the second controlled device, corresponding to the access point devices 2 to 5 are C2, C3, C4, and C5 respectively. After receiving the signal strength request instruction sent by the terminal, the second controlled device sends the four third signal strengths C2, C3, C4, and C5 to the terminal. The second signal strength and the third signal strength both include the signal strengths obtained according to the radio signals sent by the access point devices 2 to 4. It is only exemplary description herein, and no limitation is imposed thereto.

Further, the processing unit 52 is specifically configured to: determine a first difference value according to the first signal strength and the second signal strength, and determine a second difference value according to the first signal strength and the third signal strength, where the first difference value is a difference value between the first signal strength and the second signal strength that correspond to a second access point device, and the second difference value is a difference value between the first signal strength and the third signal strength that correspond to the second access point device.

The first access point device includes at least three access point devices, the first signal strength corresponds to the at least three access point devices and includes at least three first signal strengths, the second signal strength corresponds to the at least three access point devices and includes at least three second signal strengths, and the third signal strength corresponds to the at least three access point devices and includes at least three third signal strengths, and the first access point device includes the second access point device.

Optionally, the processing unit 52 is further configured to: when it is determined, according to the first difference value and the second difference value, that the distance between the first controlled device and the terminal is less than the distance between the second controlled device and the terminal, control the first controlled device and the second controlled device.

Specifically, the terminal determines the first difference value according to the first signal strength and the second signal strength, and determines the second difference value according to the first signal strength and the third signal strength, where the first difference value is a difference value between the first signal strength and the second signal strength that correspond to the second access point device, and the second difference value is a difference value between the first signal strength and the third signal strength that correspond to the second access point device, where the first access point device includes the second access point device; and when determining, according to the first difference value and the second difference value, that the distance between the first controlled device and the terminal is less than the distance between the second controlled device and the terminal, controls the first controlled device and the second controlled device.

It should be noted that, the terminal determines the first difference value according to the first signal strength and the second signal strength that correspond to a same access point device; therefore, the first controlled device and the second controlled device are required to send second signal strengths and third signal strengths that correspond to at least three identical access point devices to the terminal.

Further, the processing unit 52 is specifically configured to: when it is determined that the first difference value corresponding to the second access point device is less than the second difference value, determine that the distance between the first controlled device and the terminal is less than the distance between the second controlled device and the terminal.

It should be noted that, the terminal determines the first difference value and the second difference value according to signal strengths determined according to radio signals sent by the same access point device, in this way, the first difference value can be compared with the second difference value.

Specifically, when determining that at least three first difference values are respectively less than second difference values corresponding to corresponding access point devices, the terminal determines that the distance between the first controlled device and the terminal is less than the distance between the second controlled device and the terminal.

Exemplarily, in an application scenario of this embodiment of the present disclosure, there are five access point devices, namely, access point devices 1 to 5. The terminal obtains a signal strength A1 according to a radio signal sent by the access point device 1, the first controlled device obtains a signal strength B1 according to the radio signal sent by the access point device 1, and the second controlled device obtains a signal strength C1 according to the radio signal sent by the access point device 1. The terminal obtains a signal strength A2 according to a radio signal sent by the access point device 2, the first controlled device obtains a signal strength B2 according to the radio signal sent by the access point device 2, and the second controlled device obtains a signal strength C2 according to the radio signal sent by the access point device 2. The terminal obtains a signal strength A3 according to a radio signal sent by the access point device 3, the first controlled device obtains a signal strength B3 according to the radio signal sent by the access point device 3, and the second controlled device obtains a signal strength C3 according to the radio signal sent by the access point device 3. If it is determined that a difference value between A1 and B1 is less than a difference value between A1 and C1, a difference value between A2 and B2 is less than a difference value between A2 and C2, and a difference value between A3 and B3 is less than a difference value between A3 and C3, it is determined that the first controlled device is closer to the terminal than the second controlled device is. In addition, judgment may also be performed according to a preset threshold. If it is determined that the difference value between A1 and B1, the difference value between A2 and B2, and the difference value between A3 and B3 are all less than the preset threshold, and any one of the difference value between A1 and C1, the difference value between A2 and C2, and the difference value between A3 and C3 is greater than the preset threshold, it is determined that the first controlled device is closer to the terminal than the second controlled device is. It is only exemplary description herein, and no limitation is imposed thereto.

The sending unit 53 is further configured to send: a first control instruction to the first controlled device to instruct the first controlled device to provide a service for the terminal according to the first control instruction, and send a second instruction to the second controlled device to instruct the second controlled device to stop providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

By using the foregoing terminal, the terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

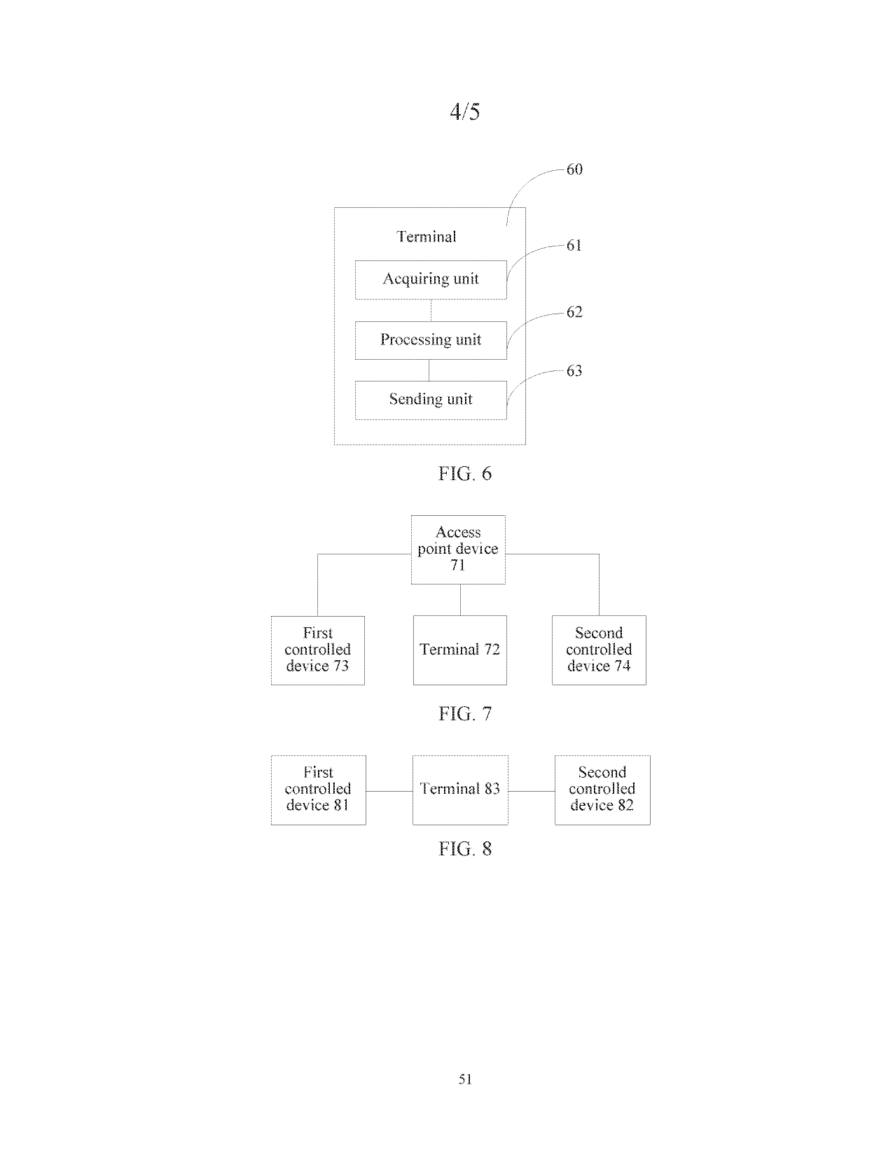

An embodiment of the present disclosure provides a terminal 60. As shown in FIG. 6, the terminal includes: an acquiring unit 61 configured to receive a first radio signal sent by a first controlled device, and receive a second radio signal sent by a second controlled device; and a processing unit 62 configured to: determine a first signal strength according to the first radio signal obtained by the acquiring unit, determine a second signal strength according to the second radio signal obtained by the acquiring unit, and when it is determined, according to the first signal strength and the second signal strength, that a distance between the first controlled device and the terminal is less than a distance between the second controlled device and the terminal, control the first controlled device and the second controlled device.

Specifically, before acquiring a first signal strength corresponding to the first controlled device and a second signal strength corresponding to the second controlled device, the terminal establishes connections to the first controlled device and the second controlled device.

Optionally, the processing unit 62 is further configured to: when it is determined that the first signal strength is greater than the second signal strength, determine that the distance between the first controlled device and the terminal is less than the distance between the second controlled device and the terminal.

The terminal further includes a sending unit 63 configured to send: a first control instruction to the first controlled device to instruct the first controlled device to provide a service for the terminal according to the first control instruction, and send a second instruction to the second controlled device to instruct the second controlled device to stop providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

An embodiment of the present disclosure provides a device control system. As shown in FIG. 7, the system includes: a first access point device 71, a terminal 72, a first controlled device 73, and a second controlled device 74, where the first access point device 71 includes at least three access point devices, where the first access point device 71 is configured to send a radio signal to the terminal, the first controlled device, and the second controlled device; the terminal 72 is configured to: receive the radio signal sent by the first access point device, determine a corresponding first signal strength according to the radio signal sent by the first access point device, acquire a second signal strength, corresponding to the first access point device, of the first controlled device and a third signal strength, corresponding to the first access point device, of the second controlled device, and when determining, according to the first signal strength, the second signal strength, and the third signal strength, that a distance between the first controlled device and the terminal is less than a distance between the second controlled device and the terminal, control the first controlled device and the second controlled device, where the first signal strength includes at least one first signal strength, the second signal strength includes at least one second signal strength, and the third signal strength includes at least one third signal strength; the first controlled device 73 is configured to: receive the radio signal sent by the first access point device, determine a corresponding second signal strength according to the radio signal sent by the first access point device, and send the second signal strength to the terminal; and the second controlled device 74 is configured to: receive the radio signal sent by the first access point device, determine a corresponding third signal strength according to the radio signal sent by the first access point device, and send the third signal strength to the terminal.

Optionally, the terminal sends the signal strength request instruction to the first controlled device and the second controlled device, and acquires the second signal strength, corresponding to the first access point device, of the first controlled device and the third signal strength, corresponding to the first access point device, of the second controlled device in the following two manners:

Manner 1: the terminal sends a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier.

Specifically, the access point device may be a Wi-Fi AP, and an identifier of the access point device may be an SSID of the Wi-Fi access point. The terminal may send a signal strength request instruction including the service set identifier to the first controlled device and the second controlled device, to instruct the first controlled device and the second controlled device to determine to send to the terminal the signal strength that is determined according to a radio signal sent by a Wi-Fi access point corresponding to the service set identifier. In this way, the terminal can send a signal request instruction including the service set identifier of a Wi-Fi access point required by the terminal to the first controlled device and the second controlled device, to instruct the first controlled device and the second controlled device to send to the terminal the first signal strength and the second signal strength that correspond to a Wi-Fi access point determined according to the service set identifier.

Exemplarily, the signal strength request instruction sent by the terminal to the first controlled device and the second controlled device includes an identifier of an access point device 1, an identifier of an access point device 2, and an identifier of an access point device 3, and then, after receiving the signal strength request instruction, the first controlled device sends a signal strength B1 corresponding to the access point device 1, a signal strength B2 corresponding to the access point device 2, and a signal strength B3 corresponding to the access point device 3; similarly, after receiving the signal strength request instruction, the second controlled device sends a signal strength C1 corresponding to the access point device 1, a signal strength C2 corresponding to the access point device 2, and a signal strength C3 corresponding to the access point device 3 to the terminal.

Manner 2: the terminal sends a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

It should be noted that, different from Manner 1, in this manner, the signal strength request instruction sent by the terminal does not include an identifier of an access point device.

In addition, the second signal strength and the third signal strength include signal strengths that are obtained by the first controlled device and the second controlled device according to radio signals sent by at least three identical access point devices.

Exemplarily, in a scenario of Manner 2, there are five access point devices, namely, access point devices 1 to 5. The first controlled device detects the access point devices 1 to 4, marks a signal strength corresponding to a radio signal sent by the access point device 1 and acquired by the first controlled device as B1, marks a signal strength corresponding to a radio signal sent by the access point device 2 and acquired by the first controlled device as B2, and so on; then, the signal strengths, acquired by the first controlled device, of the access point devices 1 to 4 are B1, B2, B3, and B4 respectively. After receiving the signal strength request instruction sent by the terminal, the first controlled device sends the four second signal strengths B1, B2, B3, and B4 to the terminal. Similarly, the second controlled device detects the access point devices 2 to 5, marks a signal strength corresponding to a radio signal sent by the access point device 2 and acquired by the second controlled device as C2, marks a signal strength corresponding to a radio signal sent by the access point device 3 and acquired by the second controlled device as C3, and so on; then, the signal strengths, acquired by the second controlled device, corresponding to the access point devices 2 to 5 are C2, C3, C4, and C5 respectively. After receiving the signal strength request instruction sent by the terminal, the second controlled device sends the four third signal strengths C2, C3, C4, and C5 to the terminal. The second signal strength and the third signal strength both include the signal strengths obtained according to the radio signals sent by the access point devices 2 to 4. It is only exemplary description herein, and no limitation is imposed thereto.

Further, the terminal determines a first difference value according to the first signal strength and the second signal strength, and determines a second difference value according to the first signal strength and the third signal strength, where the first difference value is a difference value between the first signal strength and the second signal strength that correspond to a second access point device, and the second difference value is a difference value between the first signal strength and the third signal strength that correspond to the second access point device, where the first access point device includes the second access point device; and when determining, according to the first difference value and the second difference value, that the distance between the first controlled device and the terminal is less than the distance between the second controlled device and the terminal, controls the first controlled device and the second controlled device.

It should be noted that, the terminal determines the first difference value according to the first signal strength and the second signal strength that correspond to a same access point device; therefore, the first controlled device and the second controlled device are required to send second signal strengths and third signal strengths that correspond to at least three identical access point devices to the terminal.

Further, when determining that the first difference value corresponding to the second access point device is less than the second difference value, the terminal determines that the distance between the first controlled device and the terminal is less than the distance between the second controlled device and the terminal.

It should be noted that, the terminal determines the first difference value and the second difference value according to signal strengths determined according to radio signals sent by the same access point device, in this way, the first difference value can be compared with the second difference value.

Specifically, when determining that at least three first difference values are respectively less than second difference values corresponding to corresponding access point devices, the terminal determines that the distance between the first controlled device and the terminal is less than the distance between the second controlled device and the terminal.

Exemplarily, in an application scenario of this embodiment of the present disclosure, there are five access point devices, namely, access point devices 1 to 5. The terminal obtains a signal strength A1 according to a radio signal sent by the access point device 1, the first controlled device obtains a signal strength B1 according to the radio signal sent by the access point device 1, and the second controlled device obtains a signal strength C1 according to the radio signal sent by the access point device 1. The terminal obtains a signal strength A2 according to a radio signal sent by the access point device 2, the first controlled device obtains a signal strength B2 according to the radio signal sent by the access point device 2, and the second controlled device obtains a signal strength C2 according to the radio signal sent by the access point device 2. The terminal obtains a signal strength A3 according to a radio signal sent by the access point device 3, the first controlled device obtains a signal strength B3 according to the radio signal sent by the access point device 3, and the second controlled device obtains a signal strength C3 according to the radio signal sent by the access point device 3. If it is determined that a difference value between A1 and B1 is less than a difference value between A1 and C1, a difference value between A2 and B2 is less than a difference value between A2 and C2, and a difference value between A3 and B3 is less than a difference value between A3 and C3, it is determined that the first controlled device is closer to the terminal than the second controlled device is. In addition, judgment may also be performed according to a preset threshold. If it is determined that the difference value between A1 and B1, the difference value between A2 and B2, and the difference value between A3 and B3 are all less than the preset threshold, and any one of the difference value between A1 and C1, the difference value between A2 and C2, and the difference value between A3 and C3 is greater than the preset threshold, it is determined that the first controlled device is closer to the terminal than the second controlled device is. It is only exemplary description herein, and no limitation is imposed thereto.

Further, when determining that the distance between the first controlled device and the terminal is less than the distance between the second controlled device and the terminal, the terminal sends a first control instruction to the first controlled device, to instruct the first controlled device to provide a service for the terminal according to the first control instruction, and sends a second control instruction to the second controlled device, to instruct the second controlled device to stop providing a service for the terminal according to the second control instruction.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

By using the foregoing device control system, a terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

An embodiment of the present disclosure provides a device control system. As shown in FIG. 8, the system includes a first controlled device 81, a second controlled device 82, and a terminal 83, where the first controlled device 81 is configured to send a first radio signal to the terminal; the second controlled device 82 is configured to send a second radio signal to the terminal; and the terminal 83 is configured to: determine a first signal strength according to the first radio signal, determine a second signal strength according to the second radio signal, and when determining, according to the first signal strength and the second signal strength, that a distance between the first controlled device and the terminal is less than a distance between the second controlled device and the terminal, control the first controlled device and the second controlled device.

Exemplarily, description is made by using an example in which the first controlled device is a first intelligent acoustic device, and the second controlled device is a second intelligent acoustic device. The terminal determines by using a sensor (for example, a gravity sensor, a gyroscope, or an acceleration sensor) that the terminal is in a movement state, and determines that the terminal approaches the first intelligent acoustic device and gets away from the second intelligent acoustic device; and before the terminal approaches the first acoustic device, the second intelligent acoustic device is playing an audio stream sent by the terminal; then, the terminal sends a first control instruction to the first intelligent acoustic device, and sends a second control instruction to the second intelligent acoustic device, where the first control instruction may be one or more of the following operations: waking up the first intelligent acoustic device, transferring an audio stream to the first intelligent acoustic device, and turning up volume of the first intelligent acoustic device; and the second control instruction may be one or more of the following operations: turning down volume of the second intelligent acoustic device, stopping transferring an audio stream to the second intelligent acoustic device, and enabling the second intelligent acoustic device to enter a sleeping state.

By using the foregoing device control system, a terminal receives a radio signal sent by a first access point device, determines a corresponding first signal strength according to the radio signal sent by the first access point device, acquires a second signal strength, corresponding to the first access point device, of a first controlled device and a third signal strength, corresponding to the first access point device, of a second controlled device, and when determining, according to the first signal strength, the second signal strength, and the third signal strength, that a distance between the first controlled device and the terminal is less than a distance between the second controlled device and the terminal, controls the first controlled device and the second controlled device. In this way, the terminal senses a relationship between distances between the controlled device and the terminal, so as to execute a corresponding operation according to the relationship between distances, thereby improving user experience.

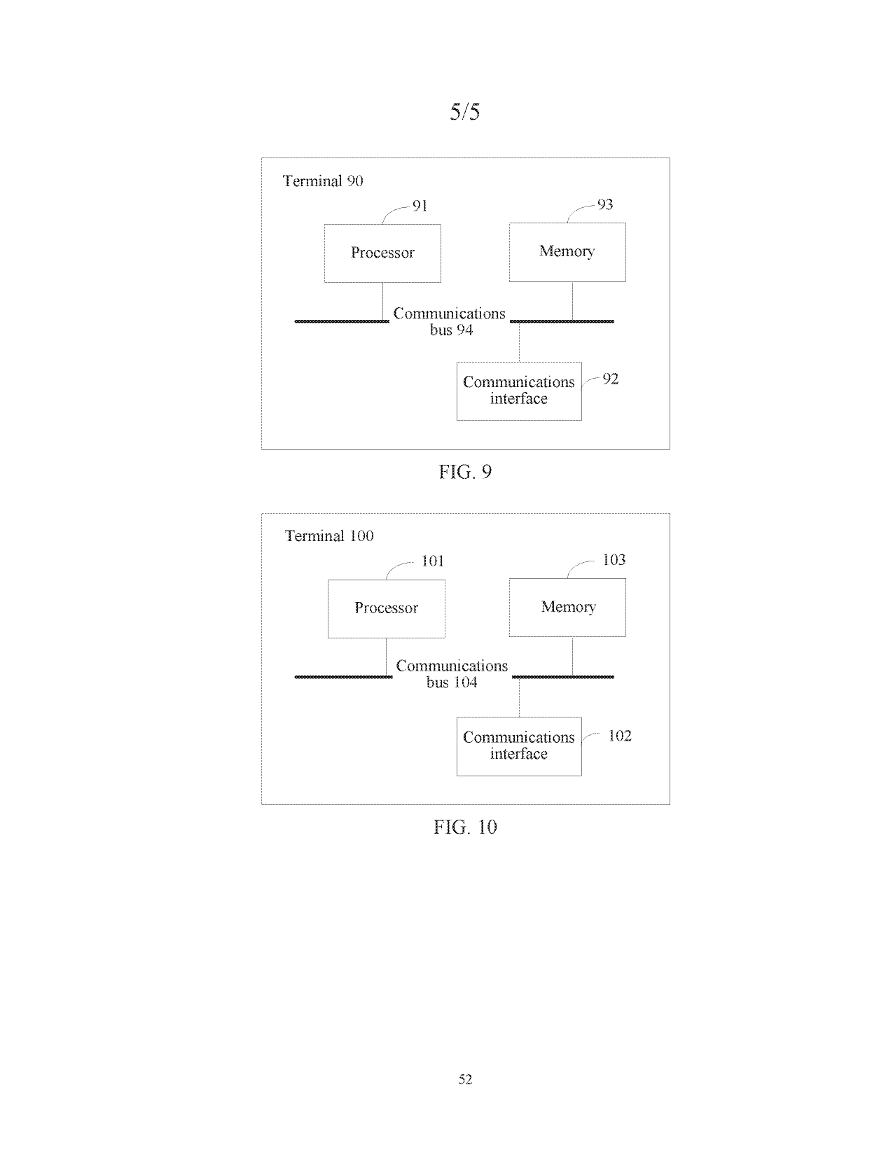

The present disclosure provides a terminal 90. As shown in FIG. 9, the terminal 90 includes: a processor 91, a communications interface 92, a memory 93, and a communications bus 94, where the processor 91, the communications interface 92, and the memory 93 communicate with each other by using the communications bus 94.

The processor 91 may be a central processing unit (CPU), or an application-specific integrated circuit (ASIC), or one or more integrated circuits configured to implement the embodiments of the present application.

The memory 93 is configured to store program code, where the program code includes a computer operation instruction. The memory 93 may include a high speed random-access memory (RAM), or may include a non-volatile memory, for example, at least one magnetic memory.

The communications interface 92 is configured to implement connection communication between the apparatuses.

The processor 91 executes the program code, and is configured to: receive a radio signal sent by a first access point device, determine a corresponding first signal strength according to the radio signal sent by the first access point device, acquire a second signal strength, corresponding to the first access point device, of a first controlled device and a third signal strength, corresponding to the first access point device, of a second controlled device, and when it is determined, according to the first signal strength, the second signal strength, and the third signal strength, that a distance between the first controlled device and the terminal is less than a distance between the second controlled device and the terminal, control the first controlled device and the second controlled device, where the first signal strength includes at least one first signal strength, the second signal strength includes at least one second signal strength, and the third signal strength includes at least one third signal strength.

Optionally, the processor 91 is further configured to send a signal strength request instruction including an identifier of the first access point device to the first controlled device and the second controlled device, to instruct the first controlled device and the second controlled device to respectively send the second signal strength and the third signal strength that correspond to the first access point device to the terminal according to the identifier.

Optionally, the processor 91 is further configured to send a signal strength request instruction to the first controlled device and the second controlled device, to instruct the first controlled device and the second controlled device to respectively send detected second signal strengths and third signal strengths that correspond to all access point devices to the terminal, where the all access point devices include the first access point device.

Optionally, the processor 91 is further configured to: determine a first difference value according to the first signal strength and the second signal strength, and determine a second difference value according to the first signal strength and the third signal strength, where the second difference value is a difference value between the first signal strength and the third signal strength that correspond to a second access point device, and when it is determined, according to the first difference value and the second difference value, that the distance between the first controlled device and the terminal is less than the distance between the second controlled device and the terminal, control the first controlled device and the second controlled device, where the first difference value is a difference value between the first signal strength and the second signal strength that correspond to the second access point device, where the first access point device includes the second access point device.

Optionally, the processor 91 is further configured to: when it is determined that the first difference value corresponding to the second access point device is less than the second difference value, determine that the distance between the first controlled device and the terminal is less than the distance between the second controlled device and the terminal, send a first control instruction to the first controlled device, to instruct the first controlled device to provide a service for the terminal according to the first control instruction, and send a second control instruction to the second controlled device, to instruct the second controlled device to stop providing a service for the terminal according to the second control instruction.

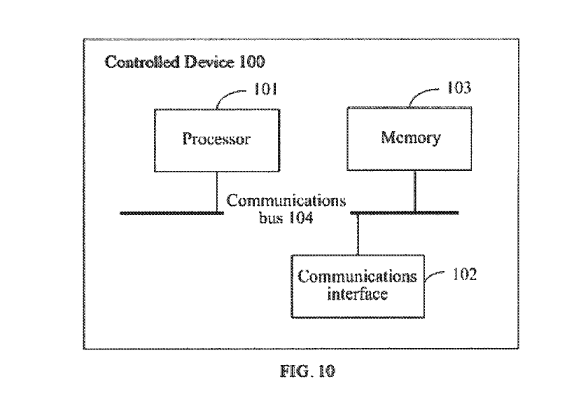

The present disclosure provides a controlled device 100. As shown in FIG. 10, the controlled device 100 includes: a processor 101, a communications interface 102, a memory 103, and a communications bus 104, where the processor 101, the communications interface 102, and the memory 103 communicate with each other by using the communications bus 104.

The processor 101 may be a CPU, or an ASIC, or one or more integrated circuits configured to implement the embodiments of the present application.

The memory 103 is configured to store program code, where the program code includes a computer operation instruction. The memory 103 may include a high speed RAM, or may include a non-volatile memory (non-volatile memory), for example, at least one magnetic memory.

The communications interface 102 is configured to implement connection communication between the apparatuses.

The processor 101 executes the program code, and is configured to: receive a first radio signal sent by a first controlled device, determine a first signal strength according to the first radio signal, receive a second radio signal sent by a second controlled device, determine a second signal strength according to the second radio signal, and when it is determined, according to the first signal strength and the second signal strength, that a distance between the first controlled device and the terminal is less than a distance between the second controlled device and the terminal, control the first controlled device and the second controlled device.

Optionally, the processor 101 is further configured to: when it is determined that the first signal strength is greater than the second signal strength, determine that the distance between the first controlled device and the terminal is less than the distance between the second controlled device and the terminal, send a first control instruction to the first controlled device, to instruct the first controlled device to provide a service for the terminal according to the first control instruction, and send a second control instruction to the second controlled device, to instruct the second controlled device to stop providing a service for the terminal according to the second control instruction.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A device control method, comprising:
receiving, by a terminal, a first radio signal sent by a first access point device, wherein the first access point device comprises at least one access point sub-device;
determining a first signal strength according to the first radio signal sent by the first access point device;
acquiring a second signal strength corresponding to a second radio signal between the first access point device and a first controlled device;
acquiring a third signal strength corresponding to a third radio signal between the first access point device and a second controlled device; and
controlling the first controlled device and the second controlled device when a first distance between the first controlled device and the terminal is less than a second distance between the second controlled device and the terminal.

2. The method according to claim 1, further comprising:
sending, to the first controlled device and the second controlled device, a signal strength request instruction comprising an identifier of the first access point device;
instructing the first controlled device to send the second signal strength to the terminal; and
instructing the second controlled device to send the third signal strength to the terminal according to the identifier.

3. The method according to claim 2, wherein the first access point device comprises at least three access point sub-devices, wherein the first signal strength corresponds to the at least three access point sub-devices and comprises at least three first signal sub-strengths, wherein the second signal strength corresponds to the at least three access point sub-devices and comprises at least three second signal sub-strengths, wherein the third signal strength corresponds to the at least three access point sub-devices and comprises at least three third signal sub-strengths, and wherein the method further comprises:
determining a first difference value between the first signal strength and the second signal strength and a second difference value between the first signal strength and the third signal; and
controlling the first controlled device and the second controlled device when determining, according to the first difference value and the second difference value, that the first distance is less than the second distance.

4. The method according to claim 3, wherein the controlling the first controlled device and the second controlled device when determining, according to the first difference value and the second difference value, that the first distance is less than the second distance comprises:
determining that the first distance is less than the second distance when determining that the first distance value is less than the second distance value;
sending a first control instruction to the first controlled device to instruct the first controlled device to provide a first service for the terminal; and
sending a second control instruction to the second controlled device to instruct the second controlled device to stop providing a second service for the terminal.

5. A device control method, comprising:
receiving, by a terminal, a first radio signal sent by a first controlled device;
determining a first signal strength according to the first radio signal;
receiving a second radio signal sent by a second controlled device;
determining a second signal strength according to the second radio signal; and
controlling the first controlled device and the second controlled device when determining, according to the first signal strength and the second signal strength, that a first distance between the first controlled device and the terminal is less than a second distance between the second controlled device and the terminal.

6. The method according to claim 5, wherein the method further comprises:
determining that the first distance is less than the second distance when determining that the first signal strength is greater than the second signal strength;
sending a first control instruction to the first controlled device to instruct the first controlled device to provide a first service for the terminal; and
sending a second control instruction to the second controlled device to instruct the second controlled device to stop providing a second service for the terminal.

7. A terminal comprising:
a receiver configured to:
receive a first radio signal sent by a first access point device, wherein the first access point device comprises at least one first access point sub-device;
acquire a second signal strength corresponding to a second radio signal between the first access point device and a first controlled device; and
acquire a third signal strength corresponding to a third radio signal between the first access point device and a second controlled device; and
a processor coupled to the memory and configured to:
determine a first signal strength according to the first radio signal; and
control the first controlled device and the second controlled device when first distance between the first controlled device and the terminal is less than a second distance between the second controlled device and the terminal.

8. The terminal according to claim 7, wherein the terminal further comprises a transmitter configured to send, to the first controlled device and the second controlled device, a signal strength request instruction comprising an identifier of the first access point device, instructing the first controlled device to send the second signal strength to the terminal, and instructing the second controlled device to send the third signal to the terminal.

9. The terminal according to claim 8, wherein the first access point device comprises at least three access point sub-devices, the first signal strength corresponds to the at least three access point sub-devices and comprises at least three first signal sub-strengths, wherein the second signal strength corresponds to the at least three access point sub-devices and comprises at least three second signal sub-strengths, and the third signal strength corresponds to the at least three access point sub-devices and comprises at least three third signal sub-strengths, and wherein the processor is further configured to:
determine a first difference value between the first signal strength and the second signal strength and a second difference value between the first signal strength and the third signal strength; and
control the first controlled device and the second controlled device when determining that the first distance is less than the second distance.

10. The terminal according to claim 9, wherein the processor is further configured to determine that the first distance is less than the second distance when the first difference value is less than the second difference value, and wherein the transmitter is further configure to:
send a first control instruction to the first controlled device to instruct the first controlled device to provide a first service for the terminal; and
send a second instruction to the second controlled device to instruct the second controlled device to stop providing a second service for the terminal.

11. A terminal comprising:
a receiver configured to:
receive a first radio signal sent by a first controlled device; and
receive a second radio signal sent by a second controlled device; and
a processor coupled to the receiver and configured to:
determine a first signal strength according to the first radio signal;
determine a second signal strength according to the second radio signal; and
control the first controlled device and the second controlled device when a first distance between the first controlled device and the terminal is less than a second distance between the second controlled device and the terminal.

12. The terminal according to claim 11, wherein the processor is further configured to determine that the first distance is less than the second distance when the first signal strength is greater than the second signal strength, and wherein the terminal further comprises a transmitter coupled to the processor and configured to:
send a first control instruction to the first controlled device to instruct the first controlled device to provide a first service for the terminal; and
send a second instruction to the second controlled device to instruct the second controlled device to stop providing a second service for the terminal.

13. A device control system comprising:
a terminal;
a first controlled device;
a second controlled device; and
a first access point device comprising at least three access point sub-devices and configured to send a first radio signal to the terminal, a second radio signal to the first controlled device, and a third radio signal to the second controlled device,
wherein the terminal is configured to:
receive the first radio signal;
determine a first signal strength according to the first radio signal;
acquire a second signal strength corresponding to the second radio signal;
acquire a third signal strength corresponding to the third radio signal; and
control the first controlled device and the second controlled device when first distance between the first controlled device and the terminal is less than a second distance between the second controlled device and the terminal,
wherein the first controlled device is configured to:
receive the second radio signal;
determine the second signal strength according to the second radio signal; and
send the second signal strength to the terminal, and
wherein the second controlled device is configured to:
receive the third radio signal;
determine the third signal strength according to the third radio signal; and
send the third signal strength to the terminal.

14. A device control system comprising:
a first controlled device;
a second controlled device; and
a terminal,
wherein the first controlled device is configured to send a first radio signal to the terminal,
wherein the second controlled device is configured to send a second radio signal to the terminal, and
wherein the terminal is configured to:
determine a first signal strength according to the first radio signal;
determine a second signal strength according to the second radio signal; and
control the first controlled device and the second controlled device when first distance between the first controlled device and the terminal is less than a second distance between the second controlled device and the terminal.

15. A terminal comprising:
a memory comprising a computer executable instruction;
a communications interface; and
a processor coupled to the memory and the communications interface using a communications bus and configured to execute the computer executable instruction,
wherein the communications interface is configured to receive a first radio signal from a first access point device,
wherein the first access point device comprises at least one first access point sub-device, and
wherein the processor is configured to:
determine a first signal strength according to the first radio signal;
acquire a second signal strength corresponding to a second radio signal between the first access point device and a first controlled device;
acquire a third signal strength corresponding to a third radio signal between the first access point device and a second controlled device; and
control the first controlled device and the second controlled device when a first distance between the first controlled device and the terminal is less than a second distance between the second controlled device and the terminal.

16. A terminal comprising:
a memory comprising a computer executable instruction;
a communications interface; and
a processor coupled to the memory and the communications interface using a communications bus and configured to execute the computer executable instruction,
wherein the communications interface is configured to:
receive a first radio signal from a first controlled device;
determine a first signal strength according to the first radio signal; and
receive a second radio signal from a second controlled device, and
wherein the processor is configured to:
determine a second signal strength according to the second radio signal; and
control the first controlled device and the second controlled device when a first distance between the first controlled device and the terminal is less than a second distance between the second controlled device and the terminal.

17. The method according to claim 1, further comprising:
transmitting to the first controlled device a first signal strength request instruction instructing the first controlled device to send the second signal strength; and
transmitting to the second controlled device a second signal strength request instruction instructing the second controlled device to send the third signal strength.

18. The terminal according to claim 15, wherein the communications interface is further configured to:
transmit to the first controlled device a first signal strength request instruction comprising an identifier of the first access point device and instructing the first controlled device to transmit the second signal strength to the terminal; and
transmit to the second controlled device a second signal strength request instruction comprising the identifier and instructing the second controlled device to transmit the third signal strength to the terminal.

19. The method according to claim 1, further comprising sending, to the first controlled device and the second controlled device, a signal strength request instruction instructing the first controlled device to send the second signal strength to the terminal and instructing the second controlled device to send the third signal strength to the terminal.

20. The terminal according to claim 7, wherein the terminal further comprises a transmitter configured to send, to the first controlled device and the second controlled device, a signal strength request instruction instructing the first controlled device to send the second signal strength to the terminal and instructing the second controlled device to send the third signal strength to the terminal.
